(19) United States
(12) Patent Application Publication
(10) Pub. No.: US 2017/0276088 A1
(43) Pub. Date: Sep. 28, 2017

(54) FUEL INJECTION DEVICE FOR INTERNAL COMBUSTION ENGINE

(71) Applicant: HONDA MOTOR CO., LTD., Tokyo (JP)

(72) Inventors: Susumu NAKAJIMA, Wako (JP); Kenji HIROSE, Wako (JP); Haruya KITANO, Wako (JP); Hidekazu HIRONOBU, Wako (JP); Tatsuo YAMANAKA, Wako (JP); Naoki YOKOYAMA, Wako (JP); Seiichi HOSOGAI, Wako (JP); Kengo NAKANO, Wako (JP)

(73) Assignee: HONDA MOTOR CO., LTD., Tokyo (JP)

(21) Appl. No.: 15/468,111

(22) Filed: Mar. 24, 2017

(30) Foreign Application Priority Data
Mar. 24, 2016 (JP) 2016-060346

(51) Int. Cl. F02D 41/40; F02D 41/00; F02M 61/04

(52) U.S. Cl. CPC F02D 41/401; F02M 61/04; F02D 41/402; F02D 41/009; F02D 2041/389

(57) ABSTRACT

A fuel injection device for an internal combustion engine including a cylinder, includes a fuel injection valve and a processor. The fuel injection valve injects fuel directly into the cylinder. The fuel injection valve has an injection hole which has a diameter and a length in an axial direction of the injection hole. A ratio of the length to the diameter being 1.0 or smaller. The processor is configured to determine, in a cold operation of the internal combustion engine, a fuel injection time during which the fuel injection valve continues to inject fuel such that an amount of soot in exhaust gas is less than an amount of soot in exhaust gas if the fuel injection valve has the ratio larger than 1.0.

### CROSS-REFERENCE TO RELATED APPLICATIONS

The present application claims priority under 35 U.S.C. §119 to Japanese Patent Application No. 2016-060346, filed Mar. 24, 2016, entitled “Fuel Injection Device for Internal Combustion Engine.” The contents of this application are incorporated herein by reference in their entirety.

### BACKGROUND

1. Field

The present disclosure relates to a fuel injection device for internal combustion engine.

2. Description of the Related Art

A fuel injection device for internal combustion engine described in Japanese Unexamined Patent Application Publication No. 2006-274945 has been conventionally known. This internal combustion engine is mounted on a vehicle as a power source and is configured as a so-called direct injection internal combustion engine in which fuel is directly injected from a fuel injection valve into a cylinder.

This fuel injection device is configured to control fuel pressure at a lower value in a cold operation of an internal combustion engine than a value in a normal operation after completion of warm-up so as to lower penetration of fuel spray. This configuration suppresses increase of soot (smoke) in exhaust gas because if penetration of fuel spray is large in a cold operation, the quantity of fuel which adheres to a wall surface of a cylinder is increased and accordingly, soot (smoke) in exhaust gas is increased.

### SUMMARY

According to one aspect of the present invention, a fuel injection device for internal combustion engine which directly injects fuel from a fuel injection valve into a cylinder, a dimensional ratio is a ratio between a length in an axial direction and a diameter in an injection hole of the fuel injection valve is set to have a value which is 1.0 or smaller. Fuel injection time by the fuel injection valve is set to have a value within a soot rapid reduction region in which fuel can be injected at a fuel quantity determined in accordance with an operation state of the internal combustion engine and soot in exhaust gas rapidly decreases compared to a case where the dimensional ratio exceeds a value which is 1.0, in a cold operation of the internal combustion engine.

According to another aspect of the present invention, a fuel injection device for an internal combustion engine including a cylinder, includes a fuel injection valve and a processor. The fuel injection valve injects fuel directly into the cylinder. The fuel injection valve has an injection hole which has a diameter and a length in an axial direction of the injection hole. A ratio of the length to the diameter being 1.0 or smaller. The processor is configured to determine, in a cold operation of the internal combustion engine, a fuel injection time during which the fuel injection valve continues to inject fuel such that an amount of soot in exhaust gas is less than an amount of soot in exhaust gas if the fuel injection valve has the ratio larger than 1.0.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 schematically illustrates the configuration of a fuel injection device according to an embodiment of the present disclosure.

FIG. 2A is a front elevational view illustrating an injection hole of a fuel injection valve and FIG. 2B illustrates IIB-IIB section of FIG. 2A.

FIG. 3A illustrates a state of fuel spray in the case where a dimensional ratio of an injection hole is large and FIG. 3B schematically illustrates a state of fuel spray in the case where a dimensional ratio of an injection hole is small.

FIG. 4 illustrates a relationship between a dimensional ratio of an injection hole and penetration.

FIG. 5 illustrates measurement results of particle diameters of fuel spray in the fuel injection valve of the present embodiment in which a dimensional ratio of an injection hole is set to a predetermined value and in a fuel injection valve in which the dimensional ratio of an injection hole is set to another predetermined value for comparison.

FIG. 6 illustrates measurement results of penetrations of fuel spray in the fuel injection valve of the present embodiment in which the dimensional ratio of an injection hole is set to a predetermined value and in a fuel injection valve in which the dimensional ratio of an injection hole is set to another predetermined value for comparison.

FIG. 7 illustrates measurement results of the number n of particles of soot per unit volume in exhaust gas with respect to fuel injection time in a cold operation of an internal combustion engine, in the fuel injection valve of the present embodiment in which the dimensional ratio of an injection hole is set to a predetermined value and in the fuel injection valve in which the dimensional ratio of an injection hole is set to another predetermined value for comparison.

FIG. 8 illustrates measurement results of the maximum reach distance of fuel spray measured by injecting fuel in identical fuel quantity for three cases: the case where the fuel was injected at once, the case where the fuel was evenly divided to be injected two separate times, and the case where the fuel was evenly divided to be injected three separate times.

FIG. 9 illustrates three fuel injection terms which are executed in cold time control processing of fuel injection control processing.

FIG. 10 is a flowchart illustrating the fuel injection control processing.

### DESCRIPTION OF THE EMBODIMENTS

The embodiments will now be described with reference to the accompanying drawings, wherein like reference numerals designate corresponding or identical elements throughout the various drawings.

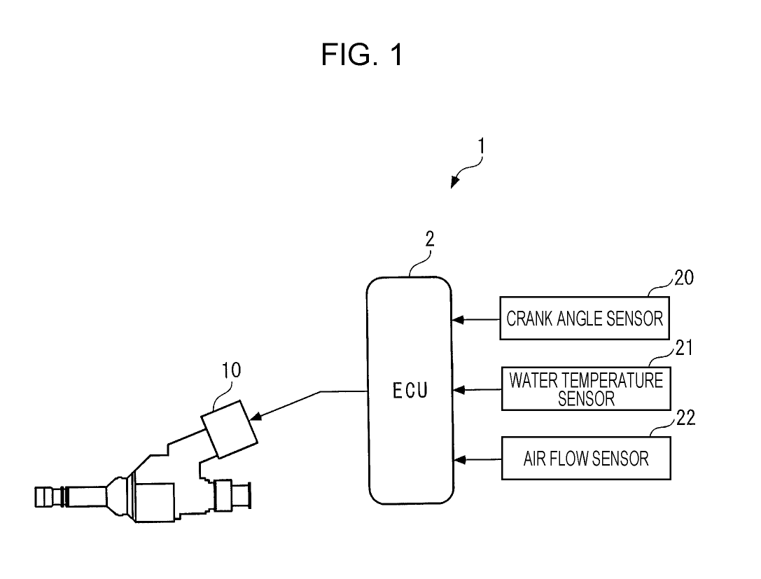

A fuel injection device for internal combustion engine according to an embodiment of the present disclosure will be described below with reference to the accompanying drawings. As illustrated in FIG. 1, this fuel injection device 1 includes a fuel injection valve 10 and an ECU 2 and the fuel injection valve 10 is electrically connected to the ECU 2. This ECU 2 controls valve opening timing and valve opening time of the fuel injection valve 10 (that is, a fuel injection term) and thus, fuel injection control processing is executed as described later.

Though not illustrated, this internal combustion engine (referred to below as an “engine”) is mounted on a vehicle (not illustrated) as a power source. The fuel injection valve 10 is a cylinder injection type valve which is provided to each cylinder, which is not illustrated, of the engine and directly injects fuel into the cylinder, and the fuel injection valve 10 is attached to a cylinder head which is not illustrated.

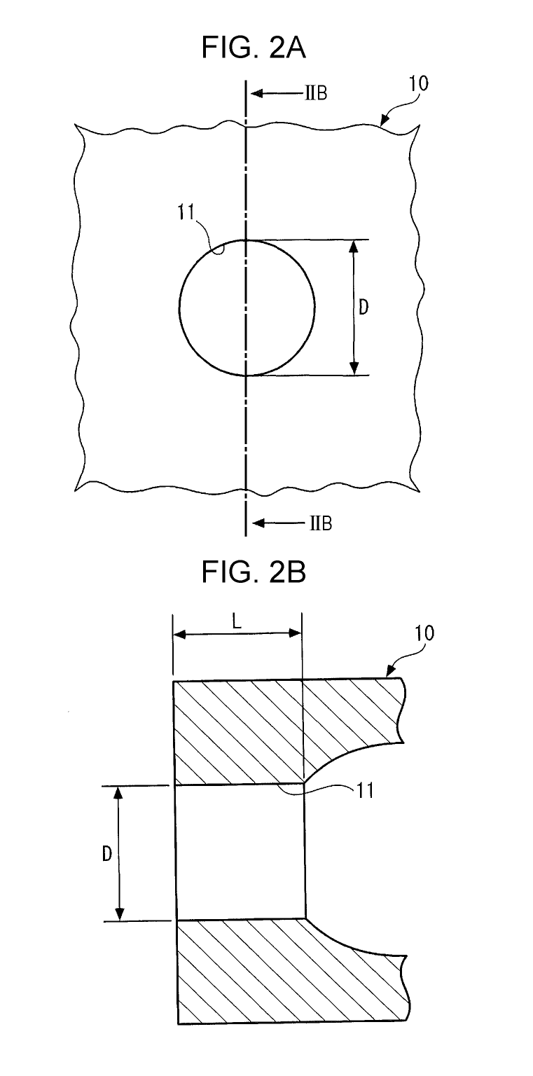

As illustrated in FIGS. 2A and 2B, a plurality of injection holes 11 (only one injection hole 11 is illustrated in FIG. 2A) are formed on a head portion of the fuel injection valve 10 and a dimensional ratio R (=L/D) which is a ratio between the length L in the axial direction of the injection hole 11 and the diameter D (refer to FIG. 2B) is set to have a predetermined value R1 (=0.9) which is equal to or smaller than a value 1.0 due to the following reasons.

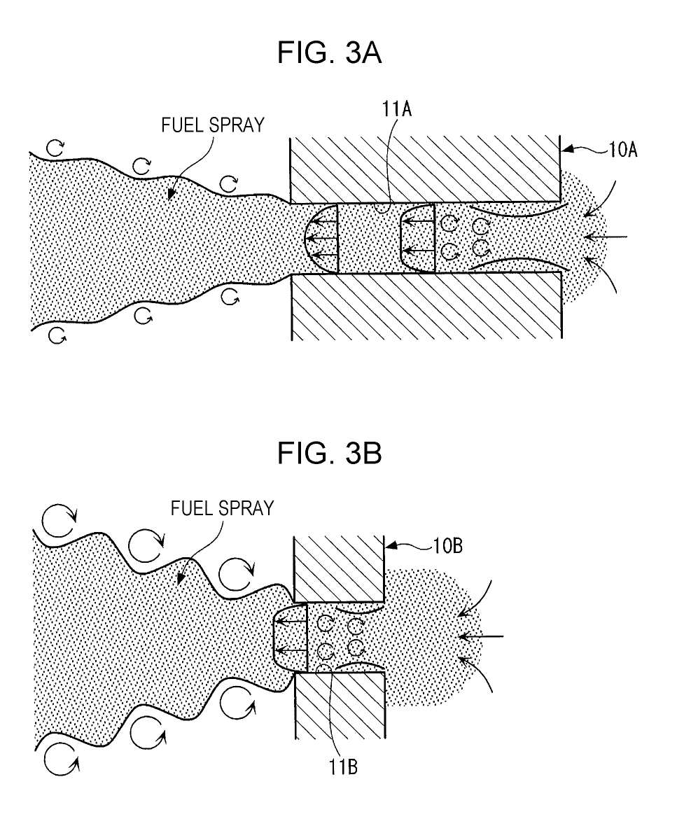

That is, in the case of a fuel injection valve 10A the dimensional ratio R of which is relatively large as illustrated in FIG. 3A, air shear and internal turbulence of fuel spray injected from an injection hole 11A are small, so that particles of the fuel spray are large and penetration is also large.

On the other hand, in the case of a fuel injection valve 10B the dimensional ratio R of which is smaller than that of the fuel injection valve 10A as illustrated in FIG. 3B, air shear and internal turbulence of fuel spray injected from an injection hole 11B are larger than those of the fuel injection valve 10A, so that particles of the fuel spray are more atomized and penetration is lowered at the same time.

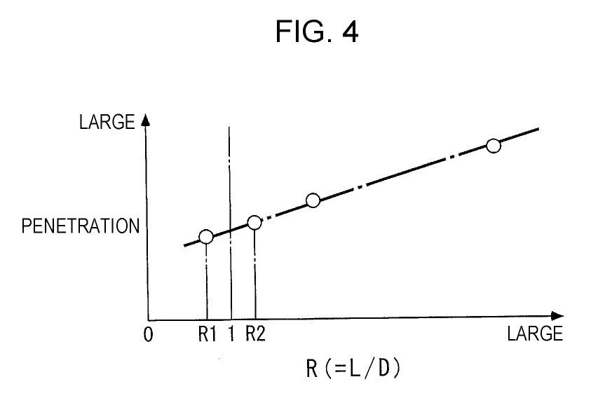

Relating to this, a relation between the dimensional ratio R and penetration was measured while changing the dimensional ratio R and the measurement result illustrated in FIG. 4 was obtained. As illustrated in FIG. 4, it is understood that penetration can be lowered as the dimensional ratio R is reduced.

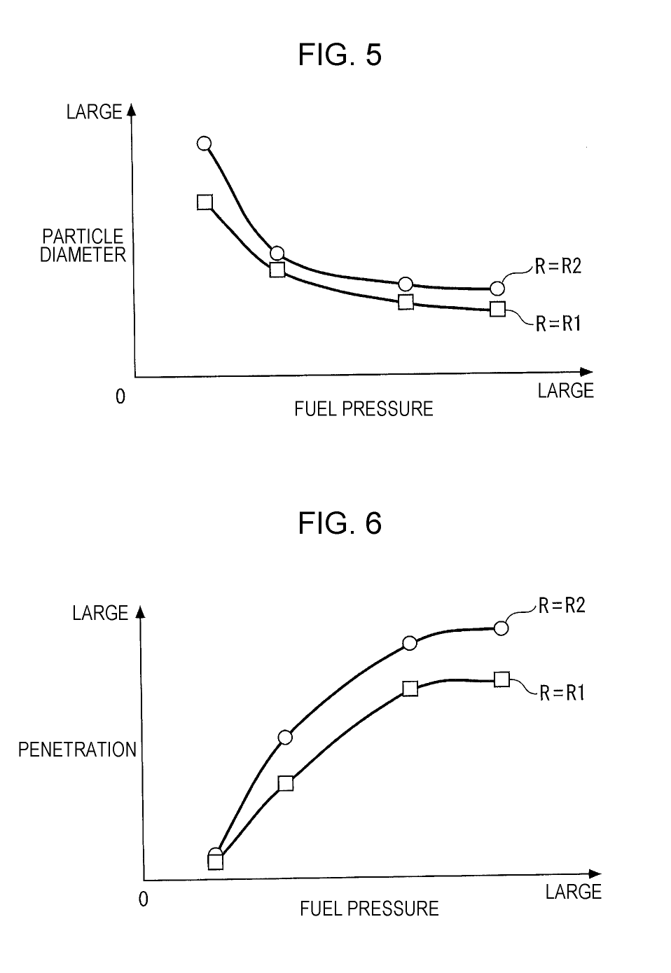

Further, through measurement of a particle diameter and penetration of fuel spray in the fuel injection valve 10, according to the present embodiment, the dimensional ratio R of which was set as R=R1 and measurement of a particle diameter and penetration of fuel spray in a fuel injection valve the dimensional ratio R of which is set to a predetermined value R2 (=1.1) which was larger than the value 1.0 for comparison, measurement results illustrated in FIGS. 5 to 7 were obtained. In FIGS. 5 to 7, measurement data indicated by squares is the measurement result of the fuel injection valve 10 according to the present embodiment (referred to below as the “present measurement result”) and data indicated by circles is the measurement result of the case setting R=R2 for comparison (referred to below as the “comparison measurement result”).

Apparent by reference to FIG. 5, it is understood that the particle diameter of fuel spray of the present measurement result is smaller than that of the comparison measurement result in the whole region of fuel pressure and thus atomization of fuel spray is realized. Further, apparent by reference to FIG. 6, it is understood that penetration of fuel spray in the present measurement result is smaller than that of the comparison measurement result in the whole region of fuel pressure and thus lowering of penetration of fuel spray is realized.

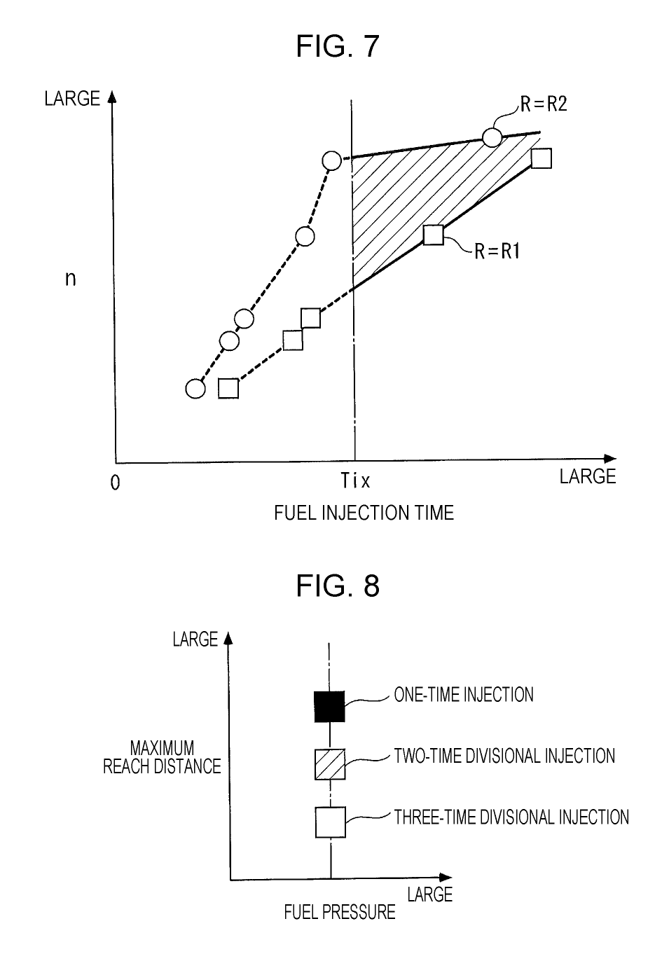

Further, the number n of particles of soot per unit volume in exhaust gas with respect to fuel injection time was measured in a cold operation of an engine and a measurement result illustrated in FIG. 7 was obtained. In this case, when the fuel quantity is determined in accordance with an operation state of the engine, injection time in which the fuel can be injected at the determined quantity is limited due to the structural reason of a fuel injection valve. In FIG. 7, Tix represents the minimum valve opening time required for injection at required fuel quantity which is required with respect to the engine in its cold operation. That is, it is impossible to inject fuel at the required fuel quantity in a region in which the fuel injection time is smaller than the minimum valve opening time Tix and thus, this region corresponds to an unpractical region.

As illustrated in FIG. 7, it is understood that the number n of particles of soot in exhaust gas in the present measurement result is largely reduced compared to that of the comparison measurement result in a region in which the fuel injection time is the minimum valve opening time Tix or longer. That is, a hatched region in FIG. 7 corresponds to a soot rapid reduction region in which soot in exhaust gas rapidly decreases in the case of the dimensional ratio R which is set to have a value equal to or smaller than the value 1.0, compared to the case of the dimensional ratio R which is larger than the value 1.0.

Further, the maximum reach distances of fuel spray were measured by injecting fuel in the identical fuel quantity for three cases: the case where the fuel was injected at once, the case where the fuel was evenly divided to be injected two separate times, and the case where the fuel was evenly divided to be injected three separate times, by using the fuel injection valve 10 according to the present embodiment, and the measurement result illustrated in FIG. 8 was obtained. As illustrated in FIG. 8, it is understood that as the number of times of divisional injection is increased, the maximum reach distance, that is, penetration can be reduced.

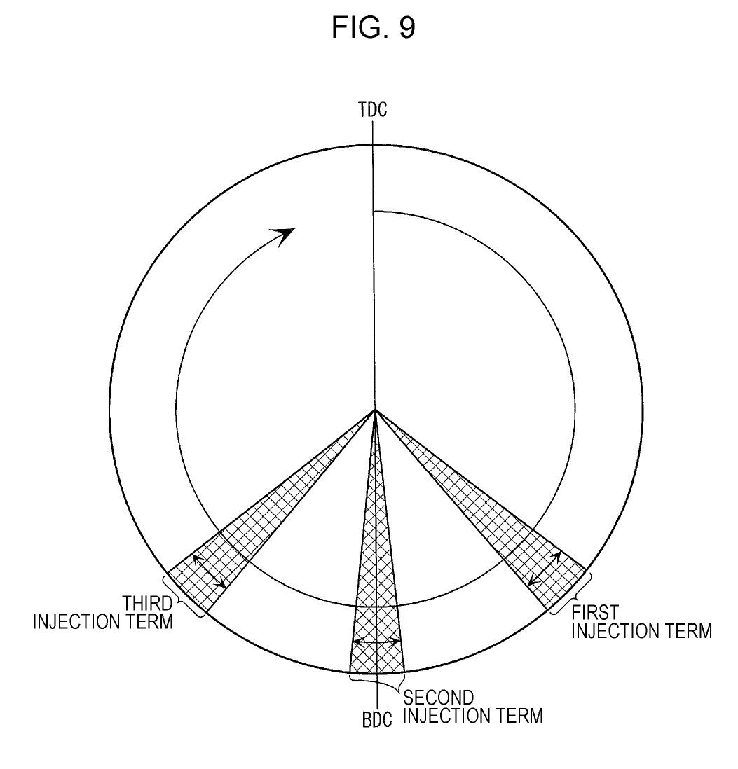

In addition to this, in the case where fuel injection is executed when a piston of a cylinder is close to the bottom dead center, a distance between an upper surface of the piston and fuel spray is long, being able to suppress the fuel quantity of fuel adhering to the upper surface of the piston and accordingly, more efficiently suppress soot in exhaust gas. Due to the above reason, in the case of the fuel injection device 1 according to the present embodiment, fuel injection is executed by dividing an injection term into three injection terms (injection periods) illustrated in FIG. 9 in the cold operation in fuel injection control processing, which will be described later, and injection time Ti required for fuel injection for one term is set to a value within the soot rapid reduction region described above.

That is, the first fuel injection is executed in the vicinity of the bottom dead center (BDC) in a manner to center a position on the advance side advanced by a predetermined crank angle from the BDC, then the second fuel injection is executed in a manner to center the BDC, and the third fuel injection is executed in the vicinity of the BDC in a manner to center a position on the delay side delayed by a predetermined crank angle from the BDC.

Meanwhile, to the ECU 2, a crank angle sensor 20, a water temperature sensor 21, and an air flow sensor 22 are electrically connected as illustrated in FIG. 1. This crank angle sensor 20 is composed of a magnet rotor and an MRE pickup and outputs a CRK signal and a TDC signal both of which are pulse signals to the ECU 2 along with rotation of a crank shaft (not illustrated) of the engine.

1 pulse of the CRK signal is outputted per predetermined crank angle (for example, 2°) and the ECU 2 calculates a rotation speed of the engine (referred to below as the “engine speed”) NE based on this CRK signal. Further, the TDC signal is a signal representing that a piston (not illustrated) of the cylinder is on a predetermined crank angle position which is on a slightly front position of a TDC position in an intake process and 1 pulse is outputted per predetermined crank angle.

Further, the water temperature sensor 21 is composed of a thermistor or the like, for example. The water temperature sensor 21 detects an engine water temperature TW which is a temperature of cooling water which circulates inside a cylinder block (not illustrated) of the engine and outputs a detection signal representing the engine water temperature TW to the ECU 2.

Further, the air flow sensor 22 detects a flow rate of intake gas (referred to below as the “intake air flow rate”) Gin which flows in an intake passage (not illustrated) of the engine and outputs a detection signal representing the intake air flow rate Gin to the ECU 2.

The ECU 2 is composed of a microcomputer constituted of a CPU, a RAM, a ROM, an I/O interface (each of which is not illustrated), and the like and executes the fuel injection control processing and the like in accordance with detection signals of various types of above-described sensors 20 to 22, as described below. Here, the ECU 2 corresponds to a first injection control unit and a second injection control unit, in the present embodiment.

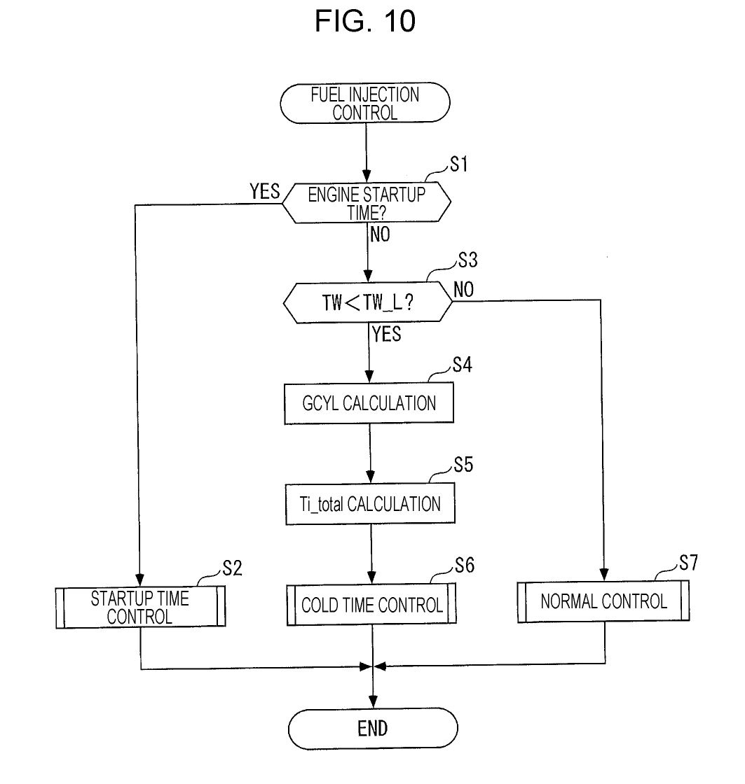

The fuel injection control processing according to the present embodiment will now be described with reference to FIG. 10. In this fuel injection control processing, fuel injection by the fuel injection valve 10 is controlled. This fuel injection control processing is executed for each cylinder by the ECU 2 in synchronization with generation timing of a TDC signal.

As illustrated in FIG. 10, whether or not to be engine startup time is determined in step 1 (abbreviated as “S1” in FIG. 10; the same shall apply hereinafter). In the case where the determination result of step 1 is YES which represents the engine startup time, the processing goes to step 2 to execute startup time control processing and the fuel injection control processing is ended. In this startup time control processing, fuel injection by the fuel injection valve 10 is controlled so as to obtain injection time and injection timing (that is, an injection term) optimal for engine startup.

On the other hand, in the case where the determination result of step 1 is NO which represents that the engine startup is completed, the processing goes to step 3 to determine whether or not the engine water temperature TW is lower than a predetermined warm-up completion value TW_L. In the case where the determination result of step 3 is YES which represents cold operation time in which warm-up of the engine is not completed, the processing goes to step 4 and a map, which is not illustrated, is searched in accordance with the intake air flow rate Gin and the like so as to calculate the intake air quantity GCYL.

Subsequently, the processing goes to step 5 and a map, which is not illustrated, is searched in accordance with the engine speed NE, the engine water temperature TW, the intake air quantity GCYL, and the like so as to calculate total injection time Ti_total. In the case of this map, the total injection time Ti_total is set so that a value obtained by evenly dividing the total injection time Ti_total into three is a value of the soot rapid reduction region described above.

Subsequently, cold time control processing is executed in step 6 and then, the fuel injection control processing is ended. In this cold time control processing, fuel injection by the fuel injection valve 10 is controlled so that the fuel injection time Ti per injection has a value obtained by evenly dividing the above-mentioned total injection time Ti_total into three and three injection terms are the injection terms (injection periods) of FIG. 9 described above.

On the other hand, the determination result of step 3 mentioned above is NO which represents that warm-up is completed, the processing goes to step 7 to execute normal control processing and then, the fuel injection control processing is ended. In this normal control processing, fuel injection by the fuel injection valve 10 is controlled in accordance with the engine speed NE, the engine water temperature TW, the intake air quantity GCYL, an air fuel ratio of exhaust gas, and the like.

According to the fuel injection device 1 of the present embodiment, the dimensional ratio R of the injection hole 11 of the fuel injection valve 10 is set to the predetermined value R1 which is equal to or smaller than a value 1.0 and the fuel injection valve 10 is controlled so that in the cold time control processing, fuel is divided into three to be respectively injected three separate times and the fuel injection time Ti per injection has a value within the soot rapid reduction region illustrated in FIG. 7, as described above. Thus, the fuel injection time Ti per injection has a value within the soot rapid reduction region, being able to efficiently suppress soot in exhaust gas. Further, fuel is divided to be injected in three separate times, so that penetration is lowered to be able to suppress the quantity of fuel adhering to a wall surface of a cylinder and accordingly, more efficiently suppress soot in exhaust gas. In addition to this, the three times of fuel injection are respectively executed in three injection terms close to the BTD illustrated in FIG. 9 described above, so that the quantity of fuel adhering to an upper surface of a piston can be suppressed and accordingly, soot in exhaust gas can be furthermore efficiently suppressed.

The present embodiment is an example in which the dimensional ratio R is set to the predetermined value R2, but the dimensional ratio of the present disclosure is not limited to this and any value which is equal to or smaller than 1.0 may be employed.

Further, the present embodiment is an example in which fuel injection by the fuel injection valve is executed three separate times in a divided manner in one combustion cycle in a cold operation of the internal combustion engine, but the method of fuel injection of the present disclosure is not limited to this and the fuel injection may be executed only one time or may be executed two separate times or four or more separate times in a divided manner in one combustion cycle. In such cases as well, it is sufficient to set fuel injection time to a value within the soot rapid reduction region in which fuel can be injected at the fuel quantity determined in accordance with an operation state of the internal combustion engine and soot in exhaust gas rapidly decreases compared to the case where the dimensional ratio exceeds a value 1.0, in the cold operation of the internal combustion engine.

Further, the present embodiment is an example in which three-time fuel injection is executed near the BDC, but fuel injection may be executed at other timing.

Further, the present embodiment is an example in which the fuel injection device of the present disclosure is applied to an internal combustion engine for vehicle, but the fuel injection device of the present disclosure is not limited to this and is applicable to an internal combustion engine for ship or internal combustion engines for other industrial instruments.

According to a first aspect of the embodiment, in a fuel injection device 1 for internal combustion engine which directly injects fuel from a fuel injection valve 10 into a cylinder, a dimensional ratio R which is a ratio between a length L in an axial direction and a diameter D in an injection hole 11 of the fuel injection valve 10 is set to have a value which is 1.0 or smaller, and fuel injection time Ti by the fuel injection valve 10 is set to have a value within a soot rapid reduction region in which fuel can be injected at a fuel quantity determined in accordance with an operation state of the internal combustion engine and soot in exhaust gas rapidly decreases compared to a case where the dimensional ratio R exceeds a value which is 1.0, in a cold operation of the internal combustion engine.

According to the fuel injection device for internal combustion engine, the dimensional ratio which is a ratio between the length in the axial direction and the diameter in an injection hole of the fuel injection valve is set to have a value which is 1.0 or smaller. Thus, through the experiment by the present applicant, it could be confirmed that when the dimensional ratio was set to have a value which was 1.0 or smaller, there was a soot rapid reduction region in which fuel could be injected at the fuel quantity determined in accordance with an operation state of the internal combustion engine and soot in exhaust gas rapidly decreased compared to the case where the dimensional ratio exceeded a value which was 1.0, in the fuel injection time in the cold operation (refer to FIG. 7 described later). Thus, according to the fuel injection device for internal combustion engine, the fuel injection time by the fuel injection valve is set to have a value which is in such soot rapid reduction region in the cold operation of the internal combustion engine, so that soot in exhaust gas can be suppressed and high merchantability can be secured in the cold operation.

According to a second aspect of the embodiment, the fuel injection device 1 for internal combustion engine according to the first aspect may include a first injection control unit (ECU 2, step 6) which controls the fuel injection valve 10 so that fuel injection by the fuel injection valve 10 is executed a plurality of separate times in a divided manner in one combustion cycle and fuel injection time Ti per execution has a value within the soot rapid reduction region, in the cold operation of the internal combustion engine.

In general, it is known that penetration can be lowered in the case where fuel injection by the fuel injection valve is executed a plurality of separate times in a divided manner in one combustion cycle. Accordingly, according to the fuel injection device for internal combustion engine, fuel injection by the fuel injection valve is executed a plurality of separate times in a divided manner in one combustion cycle and the fuel injection valve is controlled so that the fuel injection time per execution has a value within the soot rapid reduction region in the cold operation of the internal combustion engine, so that penetration is lowered to be able to further suppress the quantity of fuel adhering to a wall surface of the cylinder and more efficiently suppress soot in exhaust gas.

According to a third aspect of the embodiment, in the fuel injection device 1 for internal combustion engine according to the first or second aspect may include a second injection control unit (ECU 2, step 6) which controls the fuel injection valve 10 so that fuel injection by the fuel injection valve 10 is executed in fuel injection time Ti within the soot rapid reduction region when a piston of the cylinder is close to a bottom dead center, in the cold operation of the internal combustion engine.

According to the fuel injection device for internal combustion engine, the fuel injection valve is controlled so that fuel injection by the fuel injection valve is executed in fuel injection time within the soot rapid reduction region when a piston of the cylinder is close to a bottom dead center in the cold operation of the internal combustion engine, thereby being able to suppress the quantity of fuel adhering to an upper surface of the piston and more efficiently suppress soot in exhaust gas.

Obviously, numerous modifications and variations of the present invention are possible in light of the above teachings. It is therefore to be understood that within the scope of the appended claims, the invention may be practiced otherwise than as specifically described herein.

What is claimed is:

1. A fuel injection device for internal combustion engine which directly injects fuel from a fuel injection valve into a cylinder, wherein
a dimensional ratio which is a ratio between a length in an axial direction and a diameter in an injection hole of the fuel injection valve is set to have a value which is 1.0 or smaller, and
fuel injection time by the fuel injection valve is set to have a value within a soot rapid reduction region in which fuel can be injected at a fuel quantity determined in accordance with an operation state of the internal combustion engine and soot in exhaust gas rapidly decreases compared to a case where the dimensional ratio exceeds a value which is 1.0, in a cold operation of the internal combustion engine.

2. The fuel injection device according to claim 1, comprising:
a first injection control unit which controls the fuel injection valve so that fuel injection by the fuel injection valve is executed a plurality of separate times in a divided manner in one combustion cycle and fuel injection time per execution has a value within the soot rapid reduction region, in the cold operation of the internal combustion engine.

3. The fuel injection device according to claim 1, comprising:
a second injection control unit which controls the fuel injection valve so that fuel injection by the fuel injection valve is executed in fuel injection time within the soot rapid reduction region when a piston of the cylinder is close to a bottom dead center, in the cold operation of the internal combustion engine.

4. A fuel injection device for an internal combustion engine including a cylinder, comprising:
a fuel injection valve to inject fuel directly into the cylinder, the fuel injection valve having an injection hole which has a diameter and a length in an axial direction of the injection hole, a ratio of the length to the diameter being 1.0 or smaller; and
a processor configured to determine, in a cold operation of the internal combustion engine, a fuel injection time during which the fuel injection valve continues to inject fuel such that an amount of soot in exhaust gas is less than an amount of soot in exhaust gas if the fuel injection valve has the ratio larger than 1.0.

5. The fuel injection device according to claim 4, wherein in the cold operation of the internal combustion engine,
the processor is configured to control the fuel injection valve so that fuel injection by the fuel injection valve is executed a plurality of separate execution times in a divided manner in one combustion cycle,
the fuel is injected in the one combustion cycle at a fuel quantity determined in accordance with an operation state of the internal combustion engine, and
the fuel injection per execution time among the plurality of separate execution times is executed during the fuel injection time.

6. The fuel injection device according to claim 4, wherein the processor is configured to control the fuel injection valve so that fuel injection by the fuel injection valve is executed in the fuel injection time when a piston of the cylinder is close to a bottom dead center, in the cold operation of the internal combustion engine.

7. The fuel injection device according to claim 4, wherein,
the fuel injection time is equal to or longer than the minimum valve opening time representing a minimum valve opening time required for injection at required fuel quantity which is required with respect to the internal combustion engine in the cold operation, and
the fuel injection time is determined within a range in which a change in an amount of soot in exhaust gas with respect to the fuel injection time is larger than a change in an amount of soot in exhaust gas with respect to the fuel injection time if the fuel injection valve has the ratio larger than 1.0.
